(19) United States
(12) Patent Application Publication
(10) Pub. No.: US 2006/0010874 A1
(43) Pub. Date: Jan. 19, 2006

(54) Cooling aft end of a combustion liner

(76) Inventors: John C. Intile, Simpsonville, SC (US); Thomas R. Farrell, Simpsonville, SC (US)

Correspondence Address: J. Joseph Muller;Polster, Lieder, Woodruff & Lucchesi, L.C., Suite 200, 12412 Powerscourt Drive, St. Louis, MO, 63131-3615, US

(21) Appl. No.: 10/891,966

(22) Filed: Jul. 15, 2004

(51) Int. Cl. F02C 7/12

(52) U.S. Cl. 60/752; 60/806

(57) ABSTRACT

A liner (18) installed in a transition region (16) between a combustion section (12) of a gas turbine engine (10) and an air discharge section (14) of the turbine. The liner has an air inlet (26) for admitting air into the liner, and an air outlet (28) by which air is discharged from the liner. Flow of air through the liner acts to cool air flowing through the transition region of the turbine between the combustion and air discharge sections thereof, so to lower the temperature from between 2800-3000° F. to around 1400-1550° F. The liner has at least one channel (C1, C2) formed in it for flow of air through the liner. The height of this channel uniformly decreases along the length of the channel from the liner's air inlet to its air outlet. This liner construction reduces the thermal strain occurring at the aft end of the liner, prolonging the useful life of the liner, while reducing the amount of air needed to flow through the liner to affect a desired level of cooling in the transition region.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to internal cooling within a gas turbine engine; and more particularly, to apparatus providing better and more uniform cooling in a transition region between a combustion section and discharge section of the turbine. The apparatus, which comprises a liner of an improved design, minimizes thermal stresses in the region, while increasing the effectiveness of cooling in the region, reduces the amount of cooling air required in this portion of the turbine. This allows more air to be directed the combustion section of the turbine which improves combustion of fuel and reduces emissions (NOx).

A gas turbine engine has an air inlet section, a fuel combustion section, and an aft discharge section. There is a transition region between the combustion section of the turbine and the discharge section. A liner is installed in this transition region and has openings formed therein through which cooling air is introduced into and flows through the liner to control the temperature in the transition region. The air temperature at the upstream, inlet portion of the liner (the outlet from the combustion section of the turbine), is on the order of 2800-3000° F. At the downstream, outlet portion of the liner, the target temperature is on the order of 1400-1550° F.

Currently, the aft end of the liner is cooled by a cold side axial channel which flows air, at the turbine's compressor discharge temperature, into the region. This produces a convective, film cooling. A problem with this that the resultant cooling has been found to be not uniform; but rather there is a substantial temperature gradient between one section of the liner and another. This results in a degraded effectiveness of the cooling. To overcome this problem has heretofore required increasing the quantity of cooling air flowed into passages of the liner in order to achieve an adequate level of cooling. The resulting increased airflow to and through the liner means that air which could otherwise be directed to the combustion section of the turbine, to aid in the combustion and reduce emissions, particularly NOx emissions, must instead be diverted to the aft end of the turbine to help keep the liner temperature within permissible bounds.

### BRIEF SUMMARY OF THE INVENTION

Briefly stated, the present invention is directed to an improved liner construction for enhancing the cooling in the transition region of a turbine engine between its combustion and discharge sections. The improvement of the invention comprises a liner having an air flow or cooling passage whose cross-section varies along the length of the liner. That is, the height of the channel decreases along the length of the liner from an air inlet to an air outlet of the liner. In one embodiment of the invention, the height of the liner is reduced by approximately 60% from the inlet to the outlet end of the liner. Decreasing the height of the air flow channel in this way increases the cooling effect of air flowing through the channel, results in more more uniform metal temperatures, and reduces thermal stresses, partricularlt at the aft, air outlet end of the liner.

Optimizing the backside cooling of the aft end of the liner has significant advantages over current liner constructions. A particular advantage is that because of the improvement in cooling with the new liner, less air is required to flow through the liner; and, there is a balancing of the local velocity of air in the liner passage with the local temperature of the air. This now provides a constant cooling heat flux along the length of the liner passage. As a result of this, there are reduced thermal gradients and stresses within the liner. The reduced cooling air requirements also help prolong the service life of the liner. Finally, the reduced air flow requirements allows more air to be directed to the combustion section of the turbine to improve combustion and reduce turbine emissions.

The foregoing and other objects, features, and advantages of the invention will be in part apparent and in part pointed out hereinafter.

### BRIEF DESCRIPTION OF THE SEVERAL VIEWS OF THE DRAWINGS

In the accompanying drawings which form part of the specification:

FIG. 1 is a sectional view of a turbine engine illustrating a transition region between combustion and compressor air discharge sections of the turbine;

FIG. 2 is an elevation view of a prior art liner and a liner of the present invention for flowing cooling air through the transition region of the turbine;

FIG. 3 is an exploded view of a liner of the present invention;

FIG. 4 is a plan view of an aft end of a prior art liner and liner of the present invention illustrating differences in heat transfer coefficients between the two constructions; and,

FIG. 5 is a plan view of the aft end of a prior art liner and liner of the present invention illustrating the differences in predicted metal temperatures between the two constructions.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

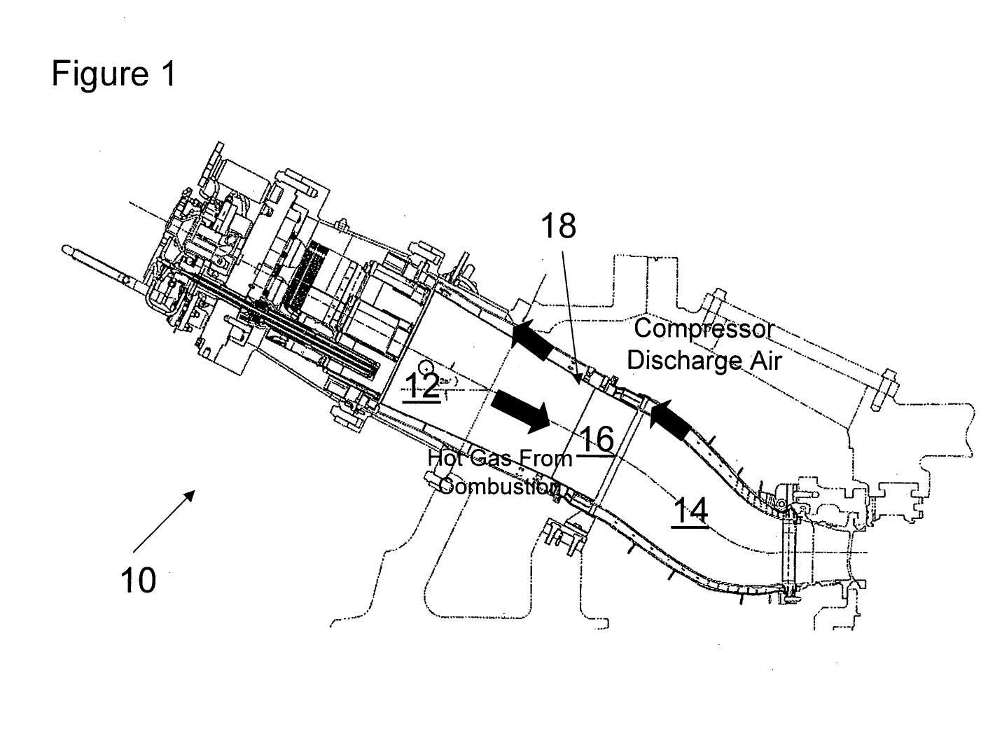

Referring to the drawings, a turbine engine is indicated generally 10 in FIG. 1. Engine 10 has a combustion section 12 where air drawn into the engine is combusted with a fuel. The engine further includes a discharge section 14. Hot gases from the combustion in section 12 flow from section 12 into section 14. There is a transition region indicated generally 16 between these two sections. As previously noted, the temperature at the aft end of section 12, the inlet portion of region 16, is on the order of 2800°-3000° F. However, the temperature at the downstream, outlet portion of region 16 is preferably on the order of 1400-1550° F. To help lower the temperature from the higher to the lower temperature range, during passage of heated gases through region 16, a liner 18 is provided through which cooling air is flowed. The cooling air serves to draw off heat from the gases and thereby lower the temperature of the gases significantly; i.e., by about 50% of the inlet temperature.

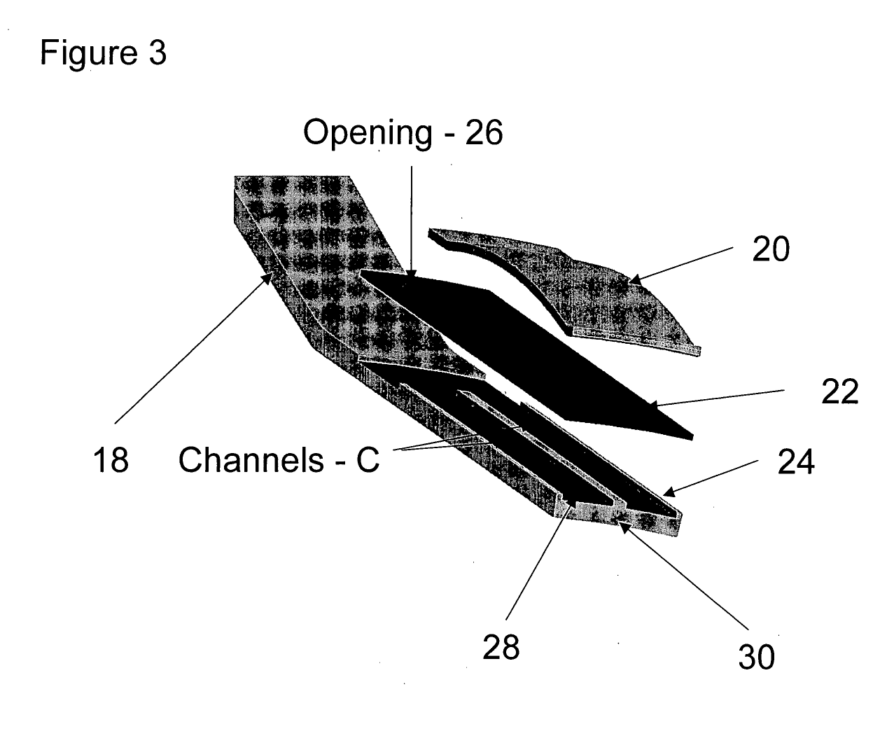

Liner 18 has an associated compression-type seal 20, commonly referred to as a hula seal, mounted between a cooling plate 22 (see FIG. 3) of the liner, and a portion of transition region 16, so to hold the cooling plate in place. As shown in FIG. 3, liner 18 has sidewalls 23 and a central raised section 24 all of which extend the length of the liner. Each sidewall and center section 24 together define respective airflow channels C1 and C2. These channels are parallel channels extending the length of liner 18. Cooling air is introduced into the liner through an air inlet slot or opening 26 at the forward end of the liner. The air then flows into and through the channels C1, C2 and exits the liner through openings 28 at an aft end 30 of the liner.

In accordance with the invention, the design of liner 18 is such as to minimize cooling air flow requirements for a given pressure drop, while still providing cooling air at a temperature that allows for sufficient heat transfer at aft end 30 of the liner to produce a uniform cooling across the liner. It will be understood by those skilled in the art that the combustion occurring within section 12 of the turbine results in a hot-side heat transfer coefficient on an inner portion of liner 18. Backside (aft end) cooling of current design liners is now required, on the outer portion of the liner, so metal temperatures and thermal stresses to which the aft end of the liner is subjected remain within acceptable limits. Otherwise, the damage to the liner resulting from the stress significantly shortens the useful life of the liner. However, because of hula seal 20, certain techniques which could otherwise be employed to cool the liner, and seal 20, cannot be used.

Liner 18 of the present invention utilizes a natural, static pressure gradient occurring between the backside and hot side of the liner to affect cooling at the aft end of the liner. This is achieved by balancing the airflow velocity in liner channels C1, C2 with the temperature of the air so to produce a constant cooling effect along the length of the channels and the liner.

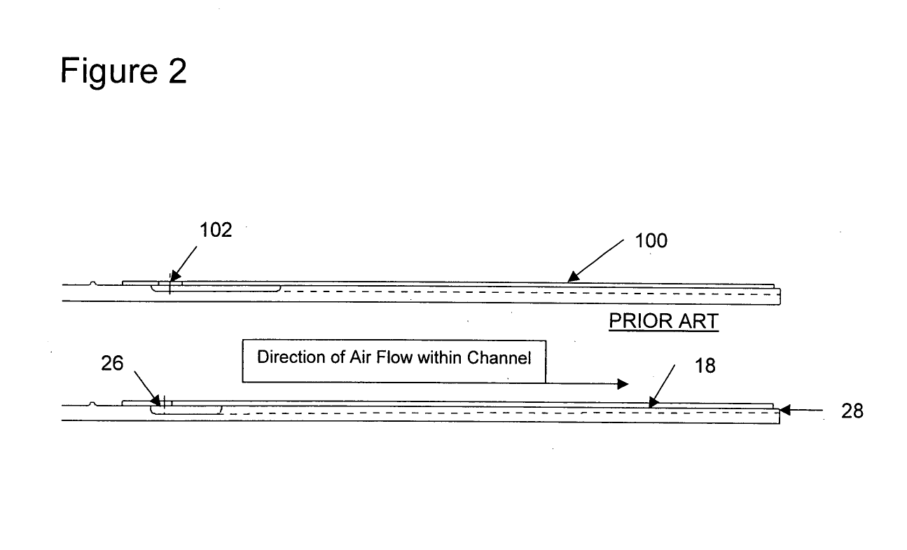

As shown in FIG. 2, a prior art liner, indicated generally 100, has a flow metering hole 102 extending across the forward end of the liner. As indicated by the dotted lines extending the length of liner 100, the cross-sectional of the liner is constant along the entire length of the liner. This thickness is, for example, 0.045″ (0.11 cm).

In contrast, liner 18 of the present invention has a thickness which is substantially (approximately 45%) greater than the thickness of liner 100 at inlet 26 to the liner. However, this thickness steadily and uniformly decreases along the length of liner 18 so that, at the aft end of the liner, the thickness is substantially (approximately 55%) less than exit thickness of prior art liner 100. Liner 18 has, for example, an entrance thickness of 0.065″ (0.16 cm) and an exit thickness of, for example, 0.025″ (0.06 cm), so the height of the liner decreases by slightly more than 60% from the inlet end to the outlet end of the liner.

In comparing prior art liner 100 with liner 18 of the present invention, it has been found that reducing the thickness of the channels (not shown) in liner 100 in order to match the cooling flow of liner 18 will not provide sufficient backside cooling to produce acceptable metal temperatures in liner 100, nor does it effectively change; i.e., minimize, the flow requirement for cooling air through the liner. Rather, it has been found that providing a variable cooling passage height within liner 18 optimizes the backside cooling at aft end 28 of the liner. With a variable channel height, an optimal cooling can be achieved because the local air velocity in the channel is now balanced with the local temperature of the cooling air flowing through the channel. That is, because the channel height is gradually reduced along the length of each channel, the cross-sectional area of the channel is similarly reduced. This results in an increase in the velocity of the cooling air flowing through channels C1, C2 and produces a constant cooling heat flux along the entire length of each channel. Liner 18 therefore has the advantage of producing a more uniform axial thermal gradient, and reduced thermal stresses within the liner. This, in turn, results in an increased useful service life for the liner. As importantly, the requirement for cooling air to flow through the liner is now substantially reduced, and this air can be routed to combustion stage 12 of the turbine to improve combustion and reduce exhaust emissions, particularly NOx emissions.

A series of CFD studies were performed using on design model of liner 18 with boundary conditions assumed to be those of a 6FA+e combustion system under base load conditions. Results of the studies indicate that, under normal operating conditions, the design of liner 18 provides sufficient cooling to the backside of the combustion liner. Predicted metal temperatures directly below air inlet slot 26 indicate significant reduction in metal temperature variations. The results also indicate approximately a 50% reduction in cooling airflow requirements to maintain equivalent trailing edge life projections.

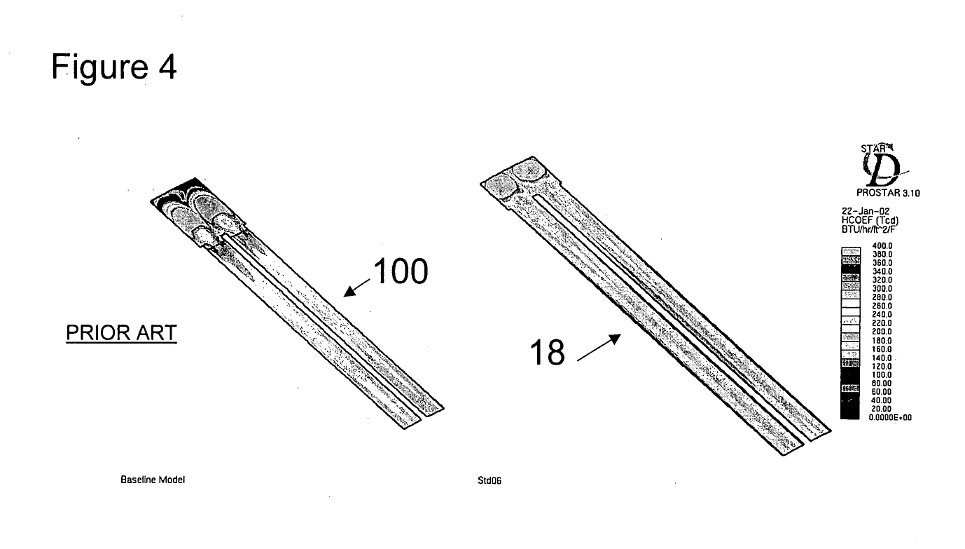

FIG. 4 is a comparison of the respective backside heat transfer coefficients at the aft end of prior art liner 100 and liner 18 of the present invention based upon the results from the studies. As shown in FIG. 4, by uniformly reducing the height of channels C1, C2 in liner 18 along the length of the liner, heat transfer characteristics are now more uniform, although of relatively the same magnitude as with liner 100. In addition, the reduced plenum feed required by liner 18 provides maximum cold-side coverage, and there are no “weak” areas of cooling. As a result, the aft end of liner 18 exhibits a significant reduction in thermal strain when compared with the aft end of liner 100.

Table 1 below summarizes, in tabular form, results from the studies.

TABLE 1

| | Liner 100 | Liner 18 |
|---|---|---|
| Geometry | | |
| Feed hole diameter (in.) | 0.2000 | 0.1250 |
| Channel length (in.) | 4.2600 | 5.0000 |
| Channel entrance height (in.) | 0.0450 | 0.0625 |
| Channel exit height (in.) | 0.0450 | 0.0250 |
| Performance | | |
| Air flow rate (lb./sec) | 1.136 | 0.571 |
| Percent water | 2.02 | 1.01 |
| Maximum metal temp. (° F.) | 1274 | 1403 |

The data presented in Table 1 indicates that cooling air flow requirements have been reduced by 50% and although the maximum metal temperature has slightly increased, thermal gradients within the material have decreased. This results in at least an equivalent useful life for the liners. Importantly, those skilled in the art will understand that the reduction of thermal gradients within liner 18 is a key factor in the design of liner 18, because the liner design minimizes the thermal stresses which occur at the aft end of the liner.

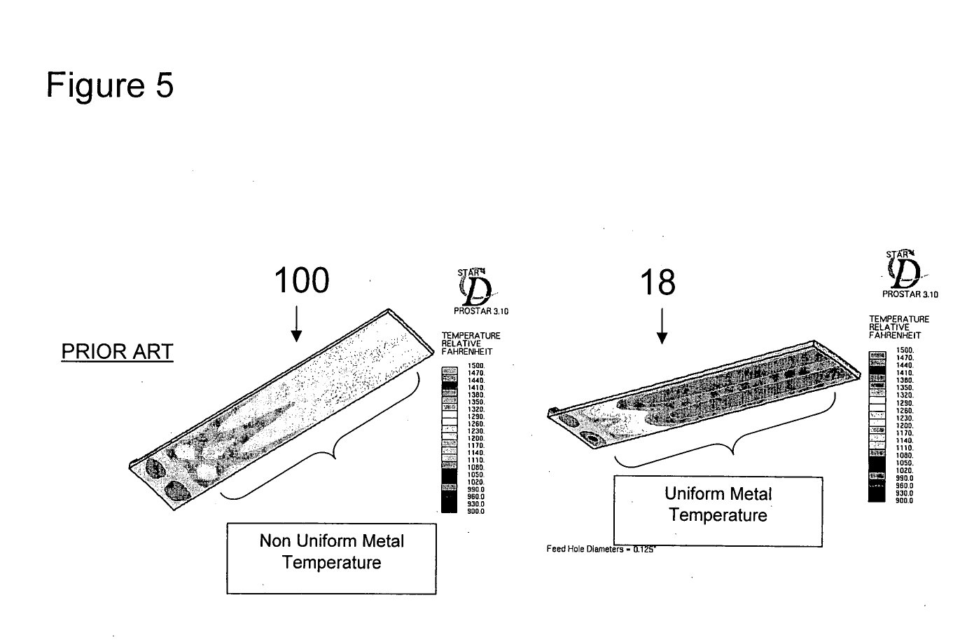

Finally, FIG. 5 represents the metal temperatures within prior art liner 100 and liner 18 of the present invention. Using boundary conditions at for a base load on turbine 10, the hot side of each liner is subject to a gas temperature of 2750° F. However, as shown in FIG. 5, liner 18 exhibits more uniform metal temperatures than liner 100. The increase in metal temperature at the aft end of liner 18 (as compared to that at the aft end of liner 100) is an acceptable performance condition for the typical thermal strains experienced at this end of the liner. As noted above, it has been found that merely reducing the channel height in a liner 100, to reduce airflow through the liner, will not produce acceptable thermal strains at these increased metal temperatures. With liner 18 of the present invention, in which the height of the liner uniformly tapers along the length of the liner, the level of thermal strain at the liner's aft end is acceptable. Again, this not only helps promote the service life of the liner but also allows a portion of the airflow which previously had to be directed through the liner to now be routed to combustion section 12 of the turbine to improve combustion and reduce emissions.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A liner (18) installed in a transition region (16) between a combustion section (12) of a gas turbine engine (10) and an air discharge section (14) of the turbine, comprising:
an air inlet (26) for admitting air into the liner and an air outlet (28) by which air is discharged from the liner, flow of air through the liner serving to cool air flowing through the transition region of the turbine between the combustion and air discharge sections thereof; and,
at least one channel (C1, C2) formed within the liner for flow of air through the liner, the height of the channel uniformly decreasing along the length of the liner from the air inlet end to the air outlet end of the liner, thereby to reduce thermal strain occurring at the aft end of the liner so to prolong the useful life of the liner and reduce the amount of air needed to flow through the liner to affect a desired level of cooling in the transition region.

2. The liner of claim 1 having two channels extending the length of the liner parallel to each other.

3. The liner of claim 2 in which the height of both channels uniformly decreases along the length of the liner from the air inlet end to the air outlet end of the liner.

4. The liner of claim 3 in which the height of the channels decreases by approximately 60% from the air inlet end to the air outlet end of the liner.

5. The liner of claim 1 which reduces the airflow through the liner required to lower the temperature in the transition region to a predetermined range of temperatures by approximately 50%, this allowing an increased flow of air to the combustion section of the turbine to improve combustion and reduce emissions.

6. In a gas turbine engine (10) having a combustion section (12), and an air discharge section (14) downstream of the combustion section, and a transition region (16) between the sections, the improvement comprising a liner (18) having an air inlet (26) for admitting air into the liner, an air outlet (28) by which air is discharged from the liner, flow of air through the liner serving to cool air flowing through the transition region of the turbine between the combustion and air discharge sections thereof, and a pair of channels (C1, C2) extending parallel to each other the length of the liner for flow of air through the liner, the height of the channels decreasing along the length of the liner from the air inlet end to the air outlet end thereof, thereby to reduce thermal strain occurring at the aft end of the liner so to prolong the useful life of the liner and reduce the amount of air needed to flow through the liner to affect a desired level of cooling in the transition region.

7. The improvement of claim 6 in which the height of the channels uniformly tapers along the length of the liner.

8. The improvement of claim 7 in which the height of the channels decreases by approximately 60% from the air inlet end to the air outlet end of the liner.

9. The improvement of claim 6 which reduces the airflow through the liner required to lower the temperature in the transition region to a predetermined range of temperatures by approximately 50%, this allowing an increased flow of air to the combustion section of the turbine to improve combustion and reduce emissions.
